(19) United States
(12) Patent Application Publication
(10) Pub. No.: US 2005/0131861 A1
(43) Pub. Date: Jun. 16, 2005

(54) Referential and relational database software

(76) Inventors: Michael Arritt, Huntington, WV (US); John Hammack, Huntington, WV (US); Kenneth Meadows, Lesage, WV (US); Rita Arritt, Huntington, WV (US)

Correspondence Address: Law Offices of John D. Gugliotta, PE, Esq., 202 Delaware Building, 137 South Main Street, Akron, OH, 44308, US

(21) Appl. No.: 11/039,257

(22) Filed: Jan. 18, 2005

Related U.S. Application Data
(63) Continuation-in-part of application No. 10/231,715, filed on Aug. 30, 2002, now abandoned.
(60) Provisional application No. 60/315,810, filed on Aug. 30, 2001.

(51) Int. Cl. G06F 7/00

(52) U.S. Cl. 707/1

(57) ABSTRACT

A referential and relational database comprising a compiled database creating a plurality of cross-linked database tables responsive to a query and yielding multi-faceted responses to the query and a full account of the data compiled in the database tables.

### RELATED APPLICATIONS

This application is a continuation-in-part of prior application Ser. No. 10/231,715, filed on Aug. 30, 2002, which claimed the benefit of U.S. Provisional Application No. 60/315,810 filed on Aug. 30, 2001.

### BACKGROUND OF THE INVENTION

1. Field of the Invention

The present invention relates generally to software database systems, and more specifically to a method for generating a compiled database wherein the database tables are completely cross-linked.

2. Description of the Related Art

In all known database programs commercially available, tracking the components of an object or item is difficult. This difficulty is compounded by the database program's inability cross-link data for the object or item into a composite structure. For instance, in one industrial aspect, an object/item is logged into the database as lot number 00-0001 and then the composition of the lot number is analyzed for percentage content. After analysis, the lot number is transformed from 00-0001 to 11-0001, or some other alteration in the object/item identification method. Current database programs cannot determine that 00-0001 and 11-0001 are the same object/item unless the lot numbers are manually re-entered and re-indexed or cross-linked. Manual re-entry is inefficient allocation of resources, and provides the potential for input error.

At present, industrial laboratories employee a variety of software packages to closely monitor the quality control and/or quality assurance of the components used in manufacture and the end product(s). For instance, an industrial laboratory may use a software package for recording the measured data, a separate database software for entry of the measured data, a third software package for calibration of the testing instrumentation, and a fourth software package for tracking customer activity. The grouping of multiple software packages together to create a fully integrated laboratory has become a necessary investment for most industrial companies.

Consequently, there exists a need for new product ideas and enhancements for existing products in the software industry, especially as directed to an integrated database software system capable of replacing multiple systems with a single software system specially tailored to the needs of particular industrial laboratories.

### SUMMARY OF THE INVENTION

The present invention is a referential and relational database software program that provides a complete data control and management system. The database acquires raw data from instrumentation, making any corrections and preparing the information for final output. The database accepts or rejects calibrations or standardization based on instrument specificity and analysis-specific historical data. The database tracks instrument performance, maintenance history, standard correlation and personnel qualifications for each analysis or data set. The database will direct the operator in a step-by-step manner on subsequent steps in the analytical and reporting process. The database can track data from multiple laboratories or organizations simultaneously. The database is a fully integrated relational database that can interface with other existing databases for accounting and other purposes. The database package can take information from raw data to final report and monitor all processes involved. The database can combine analysis or over-check secondary products for accuracy and process control. The database will determine if any process or data set is not acceptable when compared to inputted requirements or limits.

Software used within an industrial setting is often directed at a single application, such as a database designed for manual data entry of quality control measurements and information. If a company wishes to monitor quality control of the manufactured product, in addition to overseeing the calibration of the instruments used for data measurements and collection, or preserving a maintenance record for the instruments, that company must invest substantial financial capital in purchasing numerous software programs necessary to meet the aforementioned desires. In addition, that company will invest many hours in the installation, training and transition from older software to new to successfully implement the many software programs. As such, the present invention provides an integrated software system which offers a database designed for manual and automated data entry collected from quality control instrumentation, oversight of instrument calibration, preservation of maintenance records for the instrumentation, preserving operator qualification records, the tracking of customer activity and a variety of valuable industrial tracking applications. Thus, the present invention successfully overcomes the problems in existing software systems, and especially in relation to industrial laboratory applications.

Briefly described in accordance with the preferred embodiment of the present invention is a method for generating a compiled database comprising creating a plurality of database tables; cross-linking the database tables; inputting requirements of the database tables; and collecting data for populating the database tables. The method further comprising querying the database tables for yielding a full account of the data compiled in the database tables. The method also comprising tracking the data from a data source; preventing external manipulation by an operator unless authorized; identifying of an authorized operator for permitting external manipulation; identifying date, time and modification performed; and recording the date, time and modification performed. The method also comprising attaching at least one object file to a sample identification when visual identification of the sample is necessary. The cross-linked tables have a set of internal qualifiers for providing results to a multi-dimensional query.

The method further comprising inputting laboratory operating procedures and test parameters; transmitting data from instrumentation to the database tables during testing; automatically populating designated database fields with the data; reviewing the data; wherein the data comprising: test data generated by the instrumentation; calibration data extracted from the instrumentation during testing, the calibration data compared to calibration parameters; operator data comprising name, department and qualifications so that proper operator authorization may be determined; organizational data comprising suppliers of testing material and customers receiving material tested by the instrumentation. The method wherein the laboratory operating procedures include a testing process and tolerance ranges for the testing process. The method wherein transmission of the data between the database tables and the instrumentation is in real time, the real time communication providing a working assay to an operator.

The database also is a system for generating a compiled database comprising a storage device; a printer; and a processor programmed to create in the storage device a plurality of database tables; cross-link the database tables; input requirements of the database tables; collect data for populating the database tables; query the database tables for yielding a full account of the data compiled in the database tables.

It is therefore an object of the present invention to provide a referential and relational database operating as an integrated system, thereby eliminating the costly and inefficient practice of using multiple software programs.

It is a feature of the present invention to provide a referential and relational database communicating with the laboratory instrumentation to provide a real time working assay.

The use of the present invention provides users with all of the materials and tools necessary to ensure that a user may install, use and/or maintain the referential and relational database.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a block diagram of the referential and relational database software;

FIG. 2 is a block diagram of the features of the database of FIG. 1;

FIG. 3 is a block diagram of the features of the database of FIG. 1;

FIG. 4 is a block diagram of the features of the database of FIG. 1; and

FIG. 5 is a block diagram of the method and features of the database.

### DESCRIPTION OF THE PREFERRED EMBODIMENTS

An overview of the referential and relational database software is helpful in explaining the operation and function of the present invention, and the benefits provided by the use of such a database. In overview, the database is a management system for tracking and/or monitoring various activities, including: the tracking/monitoring of samples through multiple testing areas; tracking instrument performance variation of values on certified materials; tracking customer activity; tracking sample turn around times; and tracking standards and standard values used in calibration, among other activities.

The database can import information from existing database formats to provide historical reference for trending and/or material limits in accordance with procedural requirements. The database can also export information to other existing databases as required. Control and oversight of the information is maintained through multilevel security in place. Data is collected from testing areas once a qualified operator releases the data from a specific testing area. The data is compiled for review and compared to all specifications and order requirements necessary for compliance. If any data fails the standards or parameters set, the database will indicate that the data is out of compliance and allow for retesting or other options that may be available to the operator. A qualified operator performs a final review for determining failure or acceptance of the data received.

The referential and relational database accepts or imports any information or data stream from any assigned instrument, including streams of data in binary, digital or other variable forms. The instrument is identified by an assigned numerical or grammatical identity. The identity of the instrument is assigned a primary table of functions, calculations and/or reference capabilities. The initial function of the table will be to track all aspects of the instrument operation such as the individual operator operating the instrument, the last calibration (if required or necessary), any previous maintenance that was performed and the qualifications of the operator. Included in the initial function is tracking the type of sample tested, the type of test performed, corrections or adjustments performed due to calibration (if any). In addition the sample identity, the area from which the sample was received, the date the sample was received, the individual or department that received the sample and logged in the sample and the individual's qualifications and security code clearance for operators. The database can also track the customer from who the sample was received, the history of the customer, the history of that customers samples, the customer's identity assigned to the sample (numerical or grammatical value), and any special circumstances regarding the sample, including sample preperation, chemical or character limits, handling, testing requirements, test turn-around times, special tests, testing and/or tolerance parameters, and/or tracking needs. Additional ancillary tests may be tracked, if required.

The database also stores the order specifications for this type of material for this type of order, test times, turn-around times, material code, material limits, instrument precision, instrument accuracy (both long and short term studies as checked by certified standards for compliance) and acceptable deviation limits for each component of a certified standard. The database also stores projected and required maintenance counts and schedules (with instrument lock-out if dates or times are exceeded by a subsequent operator). An imported sample list can be run on the instrument, as well as in house qualification testing and records for instrument operators, and performance testing of operators on blind testing of certified standards run as samples. The instrument of choice hierarchy for all instruments used for testing parameters of the sample, any reruns of a sample, and history to all tests performed on individual samples or linked samples may also be stored and retrieved therefrom. Furthermore, an operator or manager can retrieve the order of material/sale for which the sample is being tested and individual who initiated the order from the database. All of these factors will have their own cross-linked tables in a fully linked database.

The cross-linked tables have a set of internal qualifiers, such as a standard operating procedure reference, component limits, security code, identification code, hierarchy code, acceptable users, and qualified analysts. The cross-linked tables of the database also have internal qualifiers useful for providing oversight or management to second order data collected during the testing procedure. The internal qualifiers may also include monthly, quarterly or annual logs for periodic review and comparison. The internal qualifiers may also include calibration limits, instrument drift, pass/fail identifier, and/or operator notification of any tests or samples which fail any part of the testing procedure performed. The internal qualifiers also may include costs, order number, billing number for tasks performed, inventory of standards on hand, number of standards used for each customer, standard deviation of test samples, acceptable deviation limits for samples, the reference standards required for the testing procedure and the sample form required for testing. The internal qualifiers may also include email notification (if selected) to inform the customer or requester of the laboratory results. The internal qualifiers also encompass any special circumstances that may be required for particular procedures. The internal qualifiers also provide the operator/manager with the ability to oversee review of tests or laboratory procedures.

Each strata of internal qualifiers of the cross-linked tables would have more and more specific tables of functions and parameters as needed based on the sample, the tests/procedures and the customer. Each of the tables would be linked in the database so that any query could be specified for the: sample, test, instrument, customer, operator, standard, standard operating procedure, department, date, material type, time, lot number of consumable materials, supplier, cost, profit amount, lag time, lead time, manufacturer, or other selectable identifier. Each linked item within each table within a central database would yield full accountability of all phases of any test performed by any qualified operator. Object files could be attached to sample identification in the cases where visual identification of the sample (such as patients in a medical facility or other circumstances) is required. The database would track information directly from the source and prevent any external manipulation by operators, overseers, management or testing facility unless required or necessary. If any manipulation was done, the identification of the qualified person along with the date, time and modification performed is recorded and attached to the sample identification.

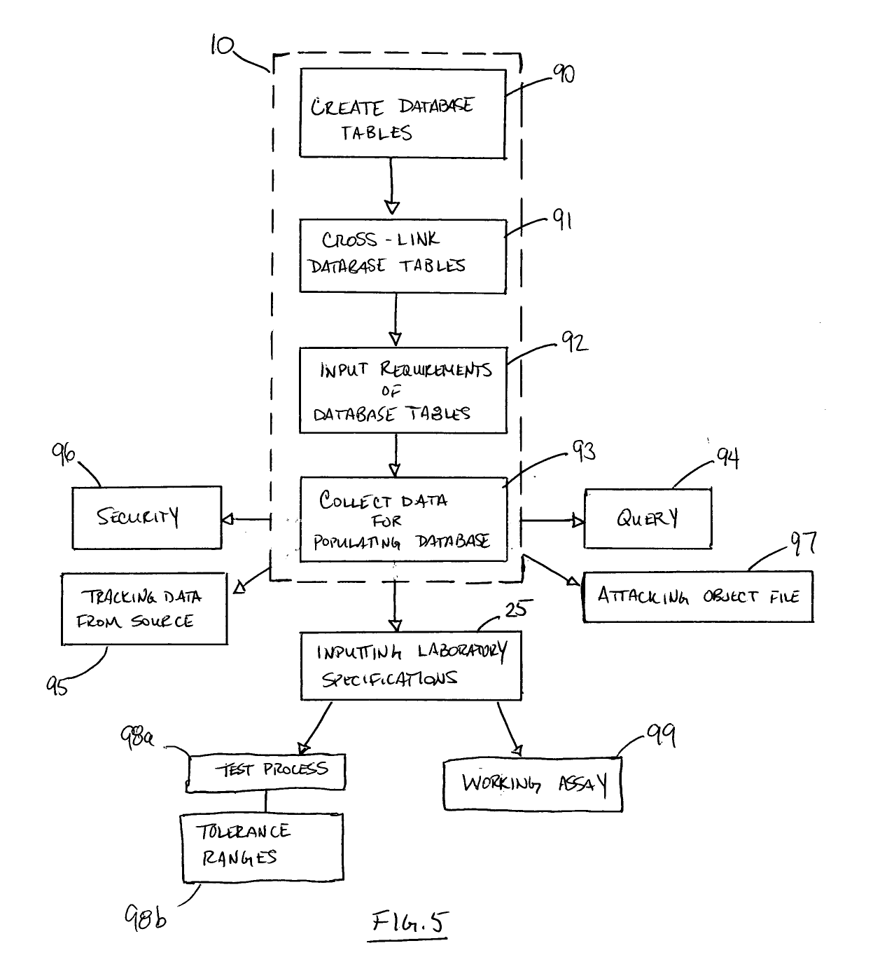

FIG. 5 depicts the aforementioned description of the database, wherein a method for generating a compiled database 10 comprising creating a plurality of database tables 90, cross-linking the database tables 91, inputting requirements of the database tables 92, and collecting data for populating the database tables 93. The method further comprising querying the database tables for yielding a full account of the data compiled in the database tables 94. The method also comprising tracking the data from a data source 95. The method also comprising security measures 96, including preventing external manipulation by an operator unless authorized, identifying of an authorized operator for permitting external manipulation, and further including identifying date, time and modification performed, and recording the date, time and modification performed. The method also comprising attaching at least one object file to a sample identification when visual identification of the sample is necessary 97. The cross-linked tables have a set of internal qualifiers for providing results to a multi-dimensional query.

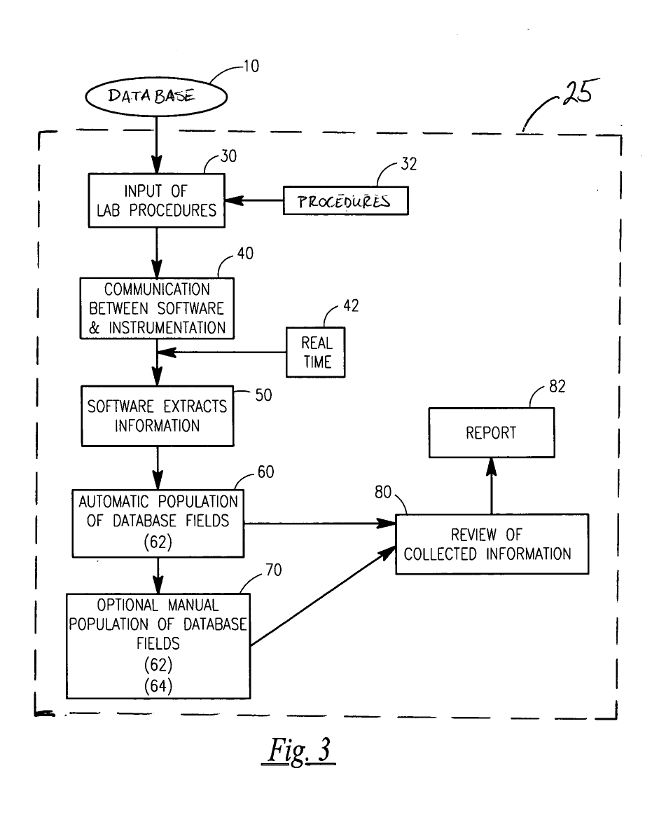

The method further comprising inputting laboratory specifications 25 (as depicted in FIG. 3), including operating procedures and test parameters; transmitting data from instrumentation to the database tables during testing; automatically. populating designated database fields with the data; reviewing the data; wherein the data comprising: test data generated by the instrumentation; calibration data extracted from the instrumentation during testing, the calibration data compared to calibration parameters; operator data comprising name, department and qualifications so that proper operator authorization may be determined; organizational data comprising suppliers of testing material and customers receiving material tested by the instrumentation. The method wherein the laboratory operating procedures include a testing process 98a and tolerance ranges 98b for the testing process. The method wherein transmission of the data between the database tables and the instrumentation is in real time, the real time communication providing a working assay 99 to an operator.

The best mode for carrying out the invention is presented in terms of its preferred embodiment, herein depicted within the Figures.

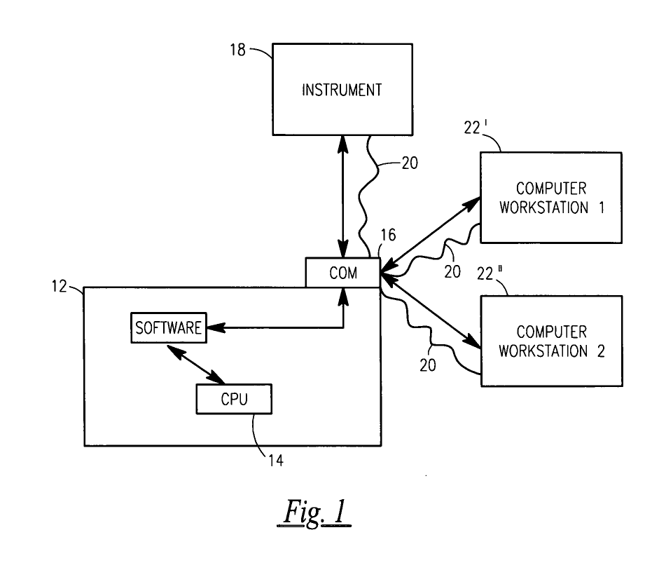

Referring now to FIG. 1, the referential and relational database software 10, in accordance with the present invention, is shown installed to the server 12 of a laboratory's computer hub. The software 10 interacts with a central processing unit (cpu) 14 and a communications port (com port) 16 for the transmission of information from device to device. The corn port 16 communicates with the instrumentation 18 via a serial cable 20. The corn port 16 further communicates with a plurality of computer workstations 22′ and 22″ through serial cables 20.

The database 10 is intended for use with any computer-readable medium having any kind of computer memory, including floppy and/or portable disks, conventional hard disks, CD-ROMS, Flash ROMS, nonvolatile ROM and RAM.

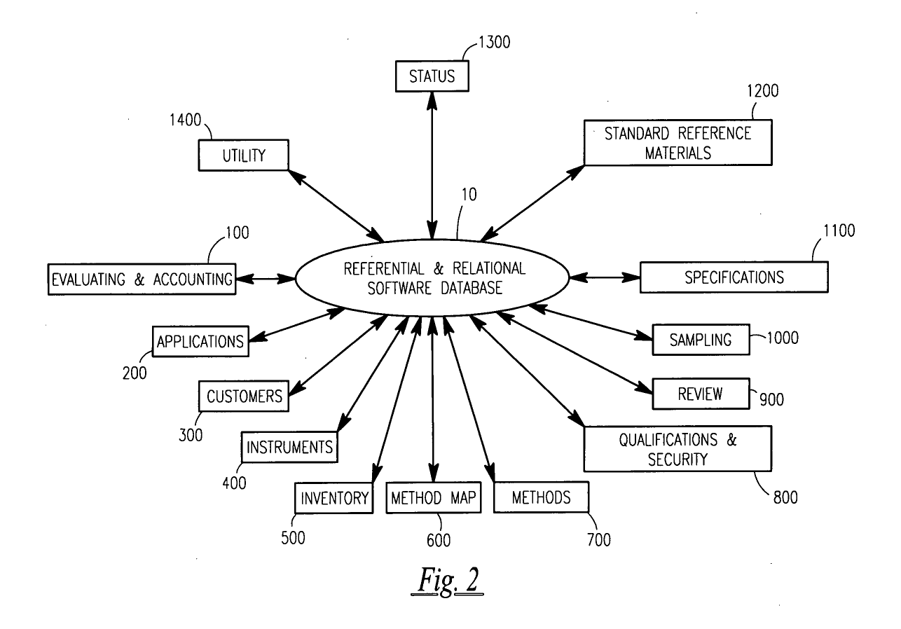

Referring now to FIG. 2, the referential and relational database 10 is shown in a general overview to facilitate an understanding of the intricate components incorporated into the database 10. The database 10 includes segmented sections for evaluating and accounting 100, applications 200, customers 300, instruments 400, inventory 500, method mapping 600, methods 700, qualifications of laboratory technicians and security measures 800, review of sampling operations 900, sample selection and tracking 1000, specifications 1100, standard reference materials 1200, status of the system 1300 and stand alone utility modules 1400.

Referring now to FIG. 3, the referential and relational database 10 includes programmable access for inputation 30 of laboratory operating procedures 32. The database 10 communicates with testing instrumentation 40, wherein the database 10 extracts information 50 from the instrumentation 18 in real time 42. As the database 10 extracts information 50 from the instrumentation 18, designated database fields 62 are automatically populated 60 with the extracted information 50. Manual population 70 of designated database fields 62 is provided as an option for pre-selected fields of for anomaly fields 64. Anomaly fields 64 are provided for manual population in which special calculations, such as conversion of units from standard to metric, or vice versa. After automated or manual population 60 or 70, the database 10 spools the information 50 into a reviewable 80 format, wherein a variety of review reports 82 may be generated for oversight and managerial control of laboratory processes 32.

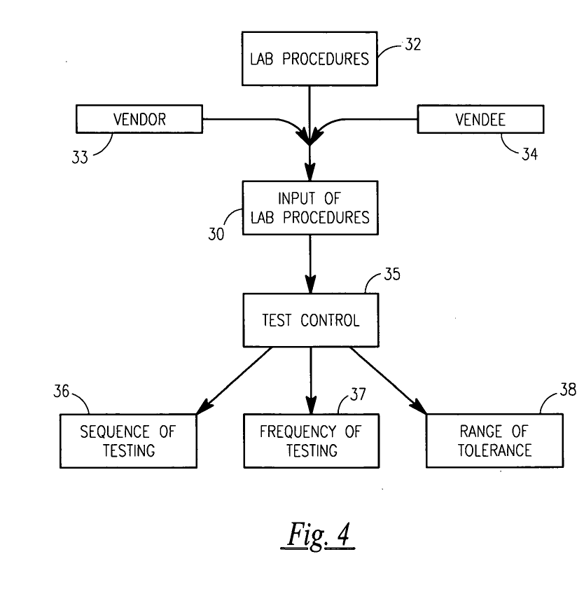

Referring now to FIG. 4, the programmable access necessary for inputation 30 of laboratory operating procedures 32 permits either a vendor 33 or a vendee 34 to input the standard laboratory operating procedures 32 of that particular laboratory. The software 10 is versatile and is adaptable for use in the simplest laboratories (having few laboratory or production procedures) or the most complex laboratories (having multiple levels of production). Preferably, the vendor 33 will customize the software 10 to suit the operating procedures 32 of the vendee 34. The operating procedures 32 will direct the software 10 to control methods of testing 35, sequence of testing 36, frequency of testing 37 and range tolerances 38.

The database 10 is integrated with the instrumentation 18 of the laboratory so as to provide communication 40 between the instrumentation 18 and a plurality of workstation computers 22′ and 22″. The communication 40 between the software 10 and the instrumentation 18 provides real time communication 40 such that as the instrumentation 18 measures and records the information, instantaneously the information is transmitted to workstation computers 22′ and 22″. The instantaneous transmission of information 50 to the workstation computers 22′ and 22″ is a working assay 52 because an operator can immediately analyze and detect any abnormalities in the testing process and efficiently correct any detected problems.

The information extracted from the instrumentation 18 includes data measured by the instrumentation 18 in analysis of a sample. The information may also include calibration data 83 of the instrumentation 18, wherein calibration data 83 is integral in providing and maintaining the integrity of the testing process as designed. The information may also include operator data 84, such as the operator's name 85, department affiliation 86, biographical data 87 or qualifications 88. The operator's qualifications 88 may include the appropriate authorization 89 necessary to operate the instrumentation 18. The information may also include organizational data 90 of a laboratory's suppliers 91 or customers 92, thereby providing an efficient and effective means for tracking components that may be received by the lab, tested by the lab and shipped by the lab to other manufacturers. This feature of the software and especially important in industries, such as metal or plastics, in which many component parts are received and ultimately pieced together to form a product. It may be necessary to investigate the integrity of the component part, such as a piece of metal incorporated into an airplane that is later involved in an accident, for example.

After the database 10 has extracted the information from the instrumentation 18, the database 10 automatically populates 60 designated fields 62 within the database. The automated population 60 occurs in real time 42, in the same manner as the information is extracted. The automated population 60 of the form fields 62 provides an efficient means for the transmission and accessibility of information to a plurality of operators or supervisors. The automated population 60 also provides means for circumventing tedious data entry from operators and eliminates the potential for data entry error. If necessary, the database 10 is adaptable for the manual population 70 of designated fields 62 or anomaly fields 64, as described above.

The database 10, after extracting information 50 from the instrumentation 18 and populating 60 and 70 fields 62, provides for an integrated overview 80 of the information collected. The overview 80 may result, if desired, in a comprehensive report 82 customized by the operator or supervisor. The report 82 generated can provide detailed explanations and analysis of samples, the testing process, the performance of the instrumentation, customer activity, sample turnaround times, and standards used in calibration of the instrumentation 18.

It is envisioned that other styles and configurations of the present invention can be easily incorporated into the teachings of the present invention, and only one particular configuration shall be shown and described for purposes of clarity and disclosure and not by way of limitation of the scope.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

1. A method for generating a compiled database comprising:
creating a plurality of database tables;
cross-linking the database tables;
inputting requirements of the database tables; and
collecting data for populating the database tables.

2. The method of claim 1 further comprising:
querying the database tables for yielding a full account of the data compiled in the database tables.

3. The method of claim 1 further comprising:
tracking the data from a data source.

4. The method of claim 1 further comprising:
preventing external manipulation by an operator unless authorized.

5. The method of claim 4 further comprising:
identifying of an authorized operator for permitting external manipulation; and
identifying date, time and modification performed; and
recording the date, time and modification performed.

6. The method of claim 1 further comprising:
attaching at least one object file to a sample identification when visual identification of the sample is necessary.

7. The method of claim 1, wherein the cross-linked tables have a set of internal qualifiers for providing results to a multi-dimensional query.

8. The method of claim 1 further comprising:
inputting laboratory operating procedures and test parameters;
transmitting data from instrumentation to the database tables during testing;
automatically populating designated database fields with the data;
reviewing the data;
the data comprising:
test data generated by the instrumentation;
calibration data extracted from the instrumentation during testing, the calibration data compared to calibration parameters;
operator data comprising name, department and qualifications so that proper operator authorization may be determined; and
organizational data comprising suppliers of testing material and customers receiving material tested by the instrumentation.

9. The method of claim 8, wherein the laboratory operating procedures include a testing process and tolerance ranges for the testing process.

10. The method of claim 8, wherein transmission of the data between the database tables and the instrumentation is in real time, the real time communication providing a working assay to an operator.

11. A computer-readable medium having computer-executable instructions for performing a method comprising:
creating a plurality of database tables;
cross-linking the database tables;
inputting requirements of the database tables;
collecting data for populating the database tables; and
querying the database tables for yielding a full account of the data compiled in the database tables.

12. The computer-readable medium of claim 11 further comprising:
tracking the data from a data source.

13. The computer-readable medium of claim 11 further comprising:
preventing external manipulation by an operator unless authorized.

14. The computer-readable medium of claim 13 further comprising:
identifying of an authorized operator for permitting external manipulation;
identifying date, time and modification performed; and
recording the date, time and modification performed.

15. The computer-readable medium of claim 11 further comprising:
attaching at least one object file to a sample identification when visual identification of the sample is necessary.

16. The computer-readable medium of claim 11, wherein the cross-linked tables have a set of internal qualifiers for providing results to a multi-dimensional query.

17. The computer-readable medium of claim 11 further comprising:
inputting laboratory operating procedures and test parameters;
transmitting data from instrumentation to the database tables during testing;
automatically populating designated database fields with the data;
reviewing the data;
the data comprising:
test data generated by the instrumentation;
calibration data extracted from the instrumentation during testing, the calibration data compared to calibration parameters;
operator data comprising name, department and qualifications so that proper operator authorization may be determined; and
organizational data comprising suppliers of testing material and customers receiving material tested by the instrumentation.

18. A system for generating a compiled database comprising:
a storage device;
a printer; and
a processor programmed to:
create in the storage device a plurality of database tables;
cross-link the database tables;
input requirements of the database tables;
collect data for populating the database tables;
query the database tables for yielding a full account of the data compiled in the database tables.

19. The system of claim 18, wherein the cross-linked tables have a set of internal qualifiers for providing results to a multi-dimensional query.

20. The system of claim 18 further comprising the processor programmed to:
input laboratory operating procedures and test parameters;
transmit data from instrumentation to the database tables during testing;
automatically populate designated database fields with the data;
review the data;
the data comprising:
test data generated by the instrumentation;
calibration data extracted from the instrumentation during testing, the calibration data compared to calibration parameters;
operator data comprising name, department and qualifications so that proper operator authorization may be determined; and
organizational data comprising suppliers of testing material and customers receiving material tested by the instrumentation.
